(19) United States
(12) Patent Application Publication
(10) Pub. No.: US 2006/0139483 A1
(43) Pub. Date: Jun. 29, 2006

(54) Scanning video camera

(76) Inventor: Woonki Jung, Cypress, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/035,085

(22) Filed: Jan. 12, 2005

(51) Int. Cl. H04N 5/225

(52) U.S. Cl. 348/373

(57) ABSTRACT

A chassis pivotally engages a scanning assembly. The scanning assembly provides a video camera, a circuit board assembly, a frame and a positioning gear, with the positioning gear able to rotate over an arcuate field of view for the camera. The chassis fixedly mounts a drive motor including a drive gear engaging the positioning gear for rotating the video camera. The frame provides opposing tabs positioned for contact with the chassis at ends of the selected arc so as to limit the range of camera motion. The chassis, scanning assembly and drive motor are mounted within a case providing a window of such curvature as to maintain a constant space between the camera and the window during camera scanning.

### BACKGROUND OF THE INVENTION

1. Related Applications: none

2. Incorporation by Reference

Applicant hereby incorporates herein by reference, the U. S. patents and U.S. patent applications referred to in the Description of Related Art section of this application.

3. Field of the Invention

This invention relates generally to video cameras for surveillance and like applications and more particularly to a video camera capable of scanning over a field of view.

4. Description of Related Art

The following art defines the present state of this field:

Rosenfield et al., U.S., Pat. No. 3,689,695, describes a television camera that is mounted on a support in a motor vehicle. The support is designed to permit the camera to have vertical movement, horizontal movement, rotary movement, tilting movement, and lateral movement across the width of the vehicle. A viewing system is mounted in the cab of the vehicle comprising three persistent image cathode ray display tubes. Rotation of the camera on a vertical axis plus appropriate control circuits provides three simultaneous continuous views of selected regions around the vehicle.

Robison, U.S. Pat. No. 4,277,804, describes an undistorted view of regions rearward of a vehicle such as a tractor-trailer that is provided by a closed circuit television system wherein a television camera having a wide angle viewing capability is positioned at the rear of the vehicle at an effective viewing elevation between about 20% and 70% of the total height of the vehicle.

The camera is protected against debilitating factors by a protective enclosure which occupies minimal space and affords secure attachment to said vehicle by virtue of a mounting wherein the axis of said camera lens is horizontally disposed in a plane perpendicular to the longitudinal axis of said vehicle. A mirror associated with said camera lens at a 45 degree angle thereto serves the two-fold purpose of permitting the desired mode of mounting of said enclosure, and reversing the image presented to said camera. The camera is connected by means of electrical wires to a television receiver positioned within easy view of the driver of the vehicle.

Petrossian et al., U.S. Pat. No. 4,910,591, describes an apparatus permitting viewing of traffic conditions to the rear and side of a motor vehicle, which has opposite sides, that comprises: (a) first and second video cameras and first and second display terminals having video screens, the cameras connected to the screens, respectively, (b) the first and second cameras mounted to the vehicle at the respective opposite sides thereof, the cameras directed generally toward the rear of the vehicle, (c) and the screens carried by the vehicle proximate the driver's position, to be viewed by the driver in that position.

Petrossian et al., U.S. Pat. No. 5,027,200, describe an apparatus that permits viewing of traffic or other conditions to the rear and side of a motor vehicle having opposite sides, and includes video camera structure mounted to the vehicle and directed sidewardly relative to the vehicle, and CRT structure operatively connected to the camera structure to display the camera output on a CRT screen zone or zones, to be viewed by the driver, and enhancement means is associated with the video camera structure to enhance viewing or scanning thereof, to the rear and side of the vehicle.

Stiepel et al., U.S. Pat. No. 5,394,209, describes a surveillance assembly in which a camera and lens assembly is surrounded by a shroud to form an eyeball assembly which is rotatable about first and second axes and which is enclosed within a housing. A carriage assembly for mounting the eyeball assembly to the housing is provided in the surveillance assembly and includes pivot and engagement parts which allow the carriage assembly to be pivoted into position. Additionally disclosed is a camera/lens mounting with a resilient annular member for permitting adjustment of the mounting along the lens axis and a cable support assembly for an electrical cable connected between a camera lens assembly and another part of a surveillance assembly in which the cable support assembly permits the cable to be wound about the pivot axis of the camera and lens assembly.

Abersfelder et al., U.S. Pat. No. 5,646,614, describes a system for monitoring the rear or front space of a motor vehicle being parked. The system is based on a video camera having an image sharpness control, which can follow an object once detected, in terms of its sharpness, with the camera's autofocus over the whole search field, for example, by using fuzzy logic. The device uses this property for an image-processing-supported tracking of the viewing angle of a video camera which is designed to be pivotable and is used for rear-space or front-space monitoring, by which an object limiting the rearward or forward penetration depth of the vehicle can be seen up until contact with the vehicle's bumper. The device eliminates obstacles which previously prevented the use of such video cameras in the rear space monitoring of private cars. A corresponding device can also be provided and used for monitoring the front space of a vehicle.

Kendrick, U.S. Pat. No. 6,175,300, describes a blind spot viewing system for viewing the blind spot of a vehicle located to the passenger side of the vehicle towards the rear of the vehicle. The system includes a video camera adapted for mounting to the passenger side of the vehicle adjacent the rear of the vehicle. The video camera has a lens facing in an outwards direction from the passenger side of the vehicle to collect images of objects in the driver's passenger side blind spot. A video monitor is electrically connected to the video camera. The video monitor is designed for positioning in the passenger compartment of the vehicle to permit a driver of the vehicle to view images from the video monitor.

Rademacher et al., U.S. 2001/0022616 describes an industrial truck, in particular a fork lift truck, that has a driver's seat that is oriented in the forward direction, at least one screen that is located in the vicinity of the driver's seat, a first camera pointing toward the rear of the industrial truck and at least one additional camera that is directed toward the rear. The first camera is provided to view a distant area and the additional camera is provided to view a near area behind the industrial truck. The image taken with the first camera and/or the image taken with the additional camera can be displayed on the screen. There are advantageously two additional cameras to view the near area.

Markus, U.S. Pat. No. 6,421,081, describes a real time video device for viewing the images at the rear and the sides of a vehicle. The real time video device includes a video camera movably mounted to the vehicle for capturing images of events occurring surrounding the vehicle and a video screen mounted within the vehicle and connected to display the images captured by the video camera. A device for moving the video camera along a horizontal plane to capture images along the horizontal plane and a device for moving the video camera along a vertical plane to capture images along the vertical plane are connected to the video camera. A manual control device is connected to the devices for moving the video camera along both the horizontal and vertical planes for capturing images along both the horizontal and vertical planes based upon desires of the driver for real time viewing by the driver of the vehicle on said video screen. An automatic control device is connected to the device for moving the video camera along the horizontal plane for capturing images along said horizontal plane based upon sensed conditions along the sides of the vehicle for display on said video screen to alert the driver to the sensed conditions thereby avoiding blind spots which inhibit the driver from driving safely.

Ikoma et al., U.S. Pat. No. 6,525,766, describes an opening formed in a hemispherical portion that decreases the rigidity of a camera cover, whereby the camera cover is easy to deform due to the lateral external pressure. In a composite camera in which a camera body is housed in a camera box (1) attached onto a ceiling or the like through a camera base (2) so that it can turn and swing up and down, and the aforesaid camera body is covered with a hemispherical camera cover (3) having an opening (3f) from which a lens (4) of the camera body protrudes, the camera cover (3) is composed of a cylindrical portion (3a), a hemispherical portion (3b) and a reinforcing step portion (3c) that connects these cylindrical portion (3a) and hemispherical portion (3b), and ring-shaped edges formed at boundaries between the cylindrical portion (3a) and the reinforcing step portion (3c) and between the reinforcing step portion (3c) and the hemispherical portion (3b) improve the lateral rigidity of the camera cover (3). Therefore, the camera cover (3) does not deform due to the lateral external forces, whereby even when the camera body is turned, the camera cover (3) does not interfere with a turn means and the like.

Hildreth, U.S. 2003/0210346, describes a housings for surveillance devices that are disclosed. In an embodiment, a housing is formed by securing a body to a hood at a sloped frame member to provide adequate sealing to protect the camera against the environment and damage. In another embodiment, the body of the housing is suitably adapted for particular applications including corner mounting. In accordance with a particular feature of the present invention, the hood includes a cylindrical aperture which provides a wide viewing angle for the device.

Moore, U.S. Pat. No. 6,690,413, describes an invention that relates to motor vehicles, and, more particularly, to a rear viewing system for tractor-trailer vehicles. An automated, universal trailer rear viewing system that is integrated in its entirety on the head or pulling portion of a pivotally connected articulated vehicle. The system includes: (a) at least one image capturing device mounted on the tractor designed to tilt, pan and focus on a target object or an area around the trailer; (b) a computer located inside the tractor coupled to the image capturing device; (c) an image capturing and comparative software program loaded into the memory of the computer capable of processing the image file of the target object transmitted from the image capturing device, and capable of generating control commands to the image capturing device so that an image of the target object is maintained as the system is activated; (d) at least one adjustable viewing camera also coupled to the computer that automatically adjusts the viewing camera tilting, panning and focusing according to the movement of the image capturing device; and, (e) at least one display monitor located near the driver that is coupled to the viewing camera so that the image seen thereby may be seen by the driver.

Wada et al., U.S. 2004/0032492 describes a surveillance camera apparatus, comprising: a housing assembly having a slanted plate portion with an inner surface; and a camera assembly accommodated in said housing assembly, said slanted plate portion forming part of said housing assembly defining an opening therein, said opening having a central axis thereof, said opening having an imaginary inner surface flush with said inner surface of said slanted plate portion forming part of said housing assembly, and said imaginary inner surface of said opening having the shape of a circle, said camera assembly, including: a stationary member; a pan shaft having a pan axis thereof, said pan shaft being supported by said stationary member to be revolvable around said pan axis; a retaining member integrally formed with said pan shaft; a tilt shaft having a tilt axis thereof, said tilt shaft being retained by said retaining member to be revolvable around said tilt axis under the state that said tilt axis of said tilt shaft is in perpendicular relationship with said pan axis of said pan shaft; an imaging unit for taking an image of a specific object through said opening of said slanted plate portion forming part of said housing assembly, said imaging unit having a light axis thereof, said imaging unit being integrally supported by said tilt shaft under the state that said light axis of said imaging unit is in perpendicular relationship with said tilt axis of said tilt shaft; a pan motor for having said pan shaft driven around said pan axis; and a controlling unit for controlling said pan motor to have said pan motor move said imaging unit around said pan axis of said pan shaft in response to the revolution of said tilt shaft to be driven around said tilt axis.

Tashiro et al., U.S. Pat. No. 6,705,774 describes a camera apparatus which includes a casing; a pan unit having an external video incident section; a pan shaft; a pan shaft support; pan driving means for rotating the pan unit about the pan shaft; a tilt unit having an internal video incident section and tilt face; a tilt shaft; tilt driving means for rotating the tilt unit about the tilt shaft; and a camera disposed inside the tilt unit. This configuration allows to visibly recognize the movement of the camera, and increases the design flexibility by covering an internal mechanism. Moreover, the apparatus may be downsized by reducing the unused space inside. Furthermore, a simple mechanism increases the productivity of the camera apparatus.

Matko et al., U.S. Pat. No. 6,762,790, describes a universal bracket that is disclosed that allows 180 degree of pitch adjustment for a camera. The camera has two brackets that can adapt to various mounting angles on any vehicle surface configuration. In addition, the universal bracket is designed to be rigid and prevent the camera from vibrating in order to prevent a blurred picture on a display unit The system is designed to be installed by a single person.

Our prior art search with abstracts described above teaches: a vehicle viewing system, a system for viewing the area rearwardly of a vehicle, a side and rear viewing apparatus for motor vehicles, an enhanced viewing at side and rear of motor vehicles, a surveillance device with eyeball assembly and pivotally mountable carriage assembly, a system for monitoring the front or rear parking space of a motor vehicle, a blind spot viewing system, an industrial truck with a camera device, a real time video rear and side viewing device for vehicles void of rear and quarter windows, a combination camera, a surveillance camera housing, a tractor-trailer viewing system, a surveillance camera apparatus, and a universal camera bracket that allows 180 degree of pitch adjustment. Thus, the prior art shows, that it is well known to provide motion control to video cameras for scanning so as to extend the range of viewing of such cameras. However, the prior art fails to teach a fully enclosed scanning video camera mounted onto a chassis with opposing tabs positioned as end stops to define the limits of motion of the camera. The prior art also fails to teach the simplified construction of the instant invention. The prior art also fails to teach the use of infrared lamps positioned lateral to the camera with isolation partition for preventing such illumination from entering the camera. The present invention fulfills these needs and provides further related advantages as described in the following summary.

### SUMMARY OF THE INVENTION

The present invention teaches certain benefits in construction and use which give rise to the objectives described below.

In a best mode embodiment of the present invention, a chassis pivotally engages a scanning assembly. The scanning assembly provides a video camera, a circuit board assembly, a frame and a positioning gear, with the positioning gear able to rotate over an arcuate field of view for the camera. The chassis fixedly mounts a drive motor including a drive gear engaging the positioning gear for rotating the video camera. The frame provides opposing tabs positioned for contact with the chassis at ends of the selected arc so as to limit the range of camera motion. The chassis, scanning assembly and drive motor are mounted within a case providing a window of such curvature as to maintain a constant space between the camera and the window during camera scanning.

A primary objective of the present invention is to provide an apparatus and method of use of such apparatus that yields advantages not taught by the prior art.

Another objective of the invention is to provide a camera with scanning drive for providing motion over an arcuate range.

A further objective of the invention is to provide such a camera with isolation from the environment.

A still further objective of the invention is to provide such a camera with night vision illumination.

A still further objective of the invention is to provide such a camera with anti-fogging capability.

A still further objective of the invention is to provide such a camera with motion end stops of simple construction and a motor drive system that is able to be idled at the end stops without damage occurring to the motor.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of the present invention shown with a video camera of the present invention positioned nominally;

FIG. 2 is a further perspective view thereof showing a scanning arc of the camera;

FIG. 3 is an exploded view thereof showing a case, the camera with operating elements and a case cover with window;

FIG. 4 is a perspective view showing the invention as mounted on a rear panel of a motor home;

FIG. 5 is an elevational view of an interior of the motor home showing a video monitor for displaying a camera scene;

FIG. 6 is a schematic diagram of the electrical circuit of a circuit board assembly of the present invention;

FIG. 7 is a schematic diagram of a DC/DC converter of the invention;

FIG. 8 is a schematic diagram of an infrared illumination circuit of the invention;

FIG. 9 is a schematic diagram of a heater circuit of the invention; and

FIG. 10 is a schematic diagram of a defogger circuit of the invention.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

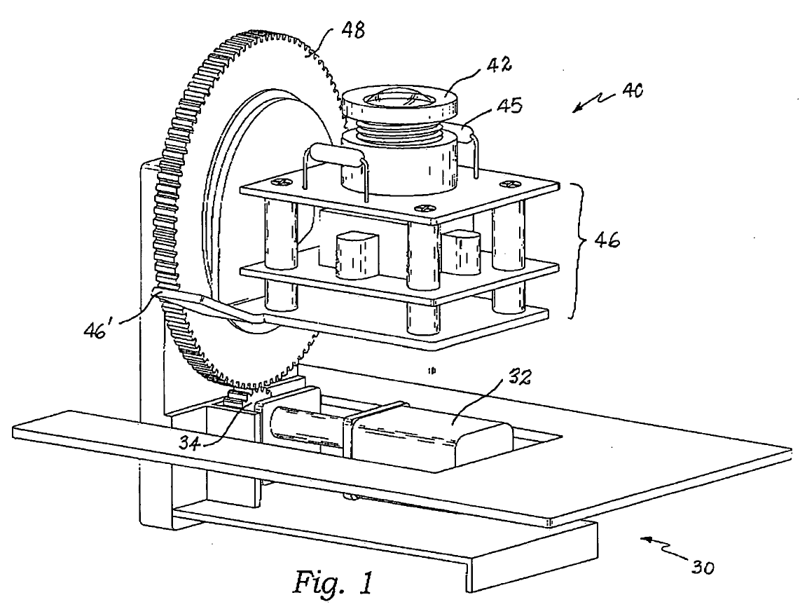

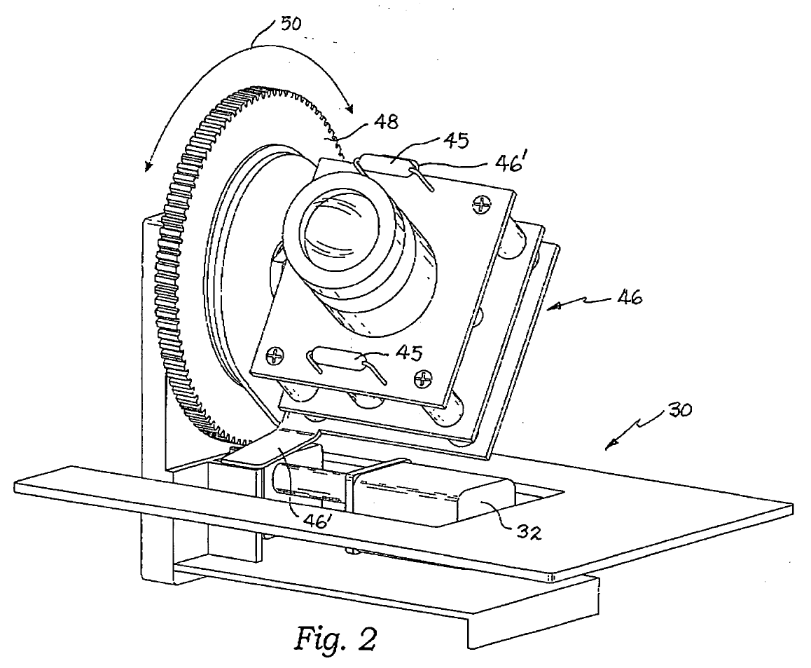

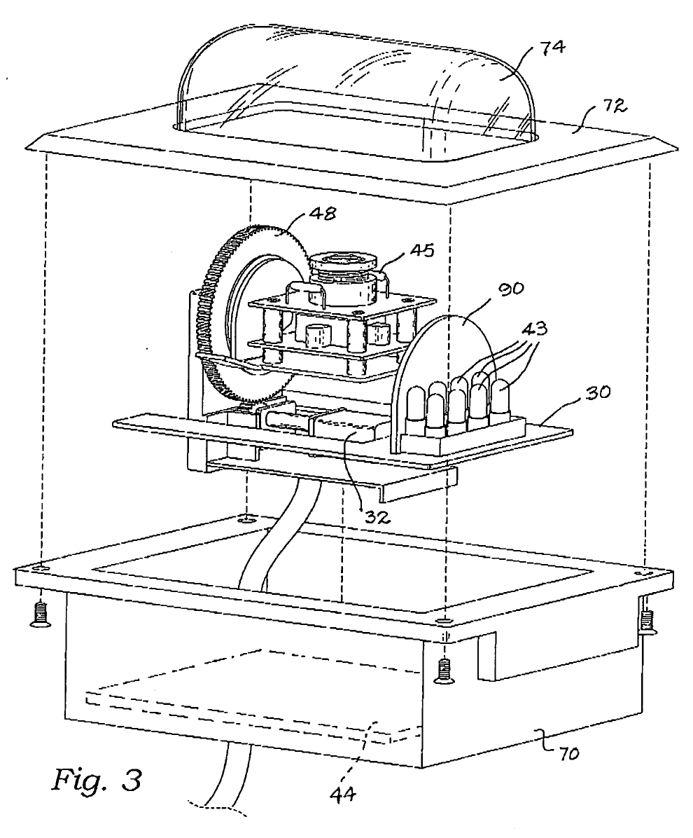

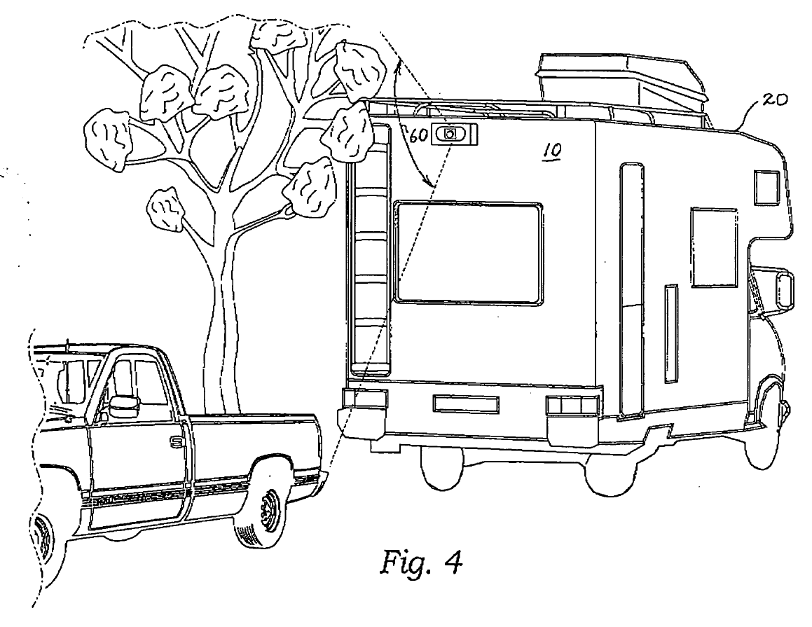

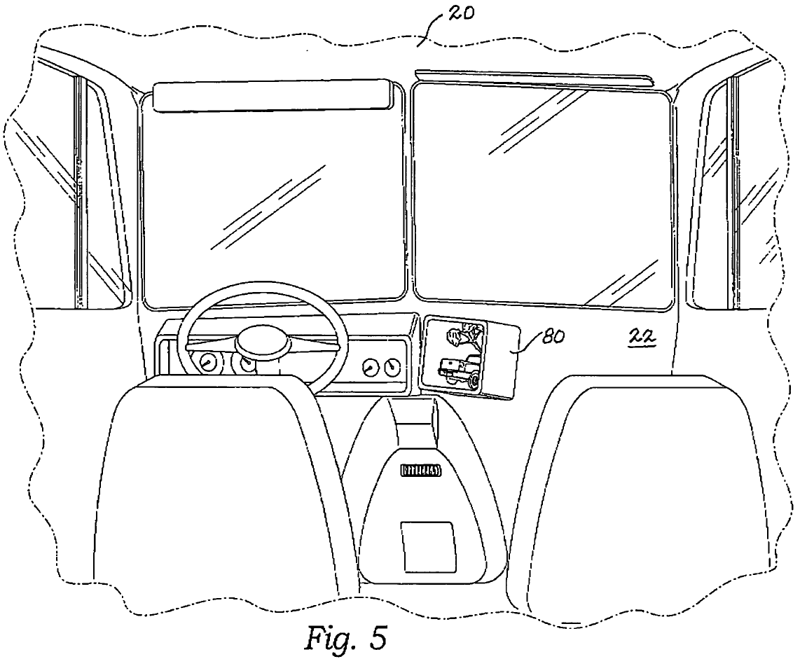

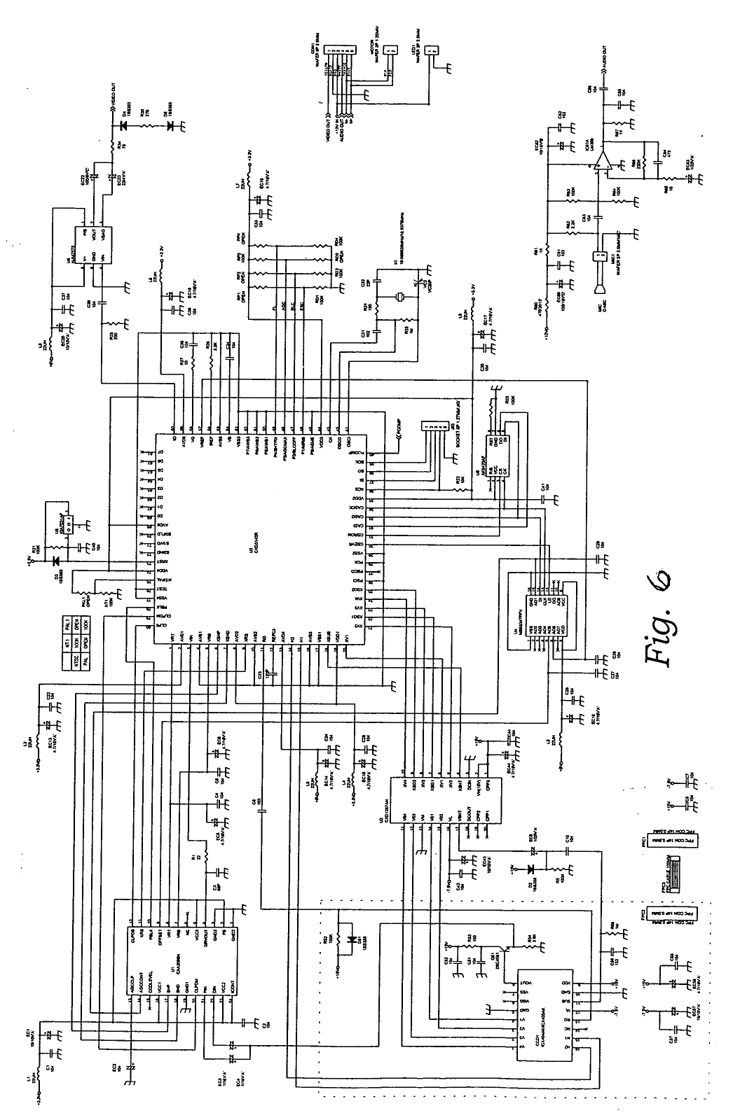

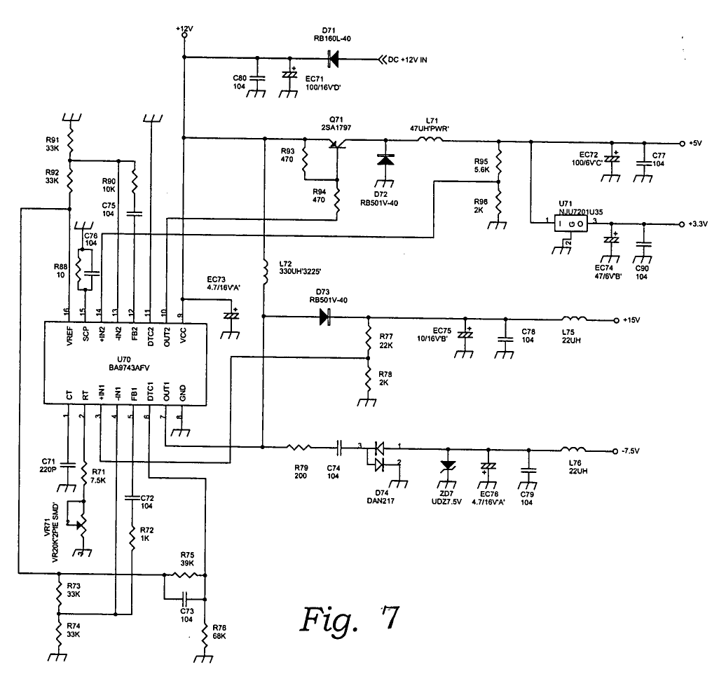

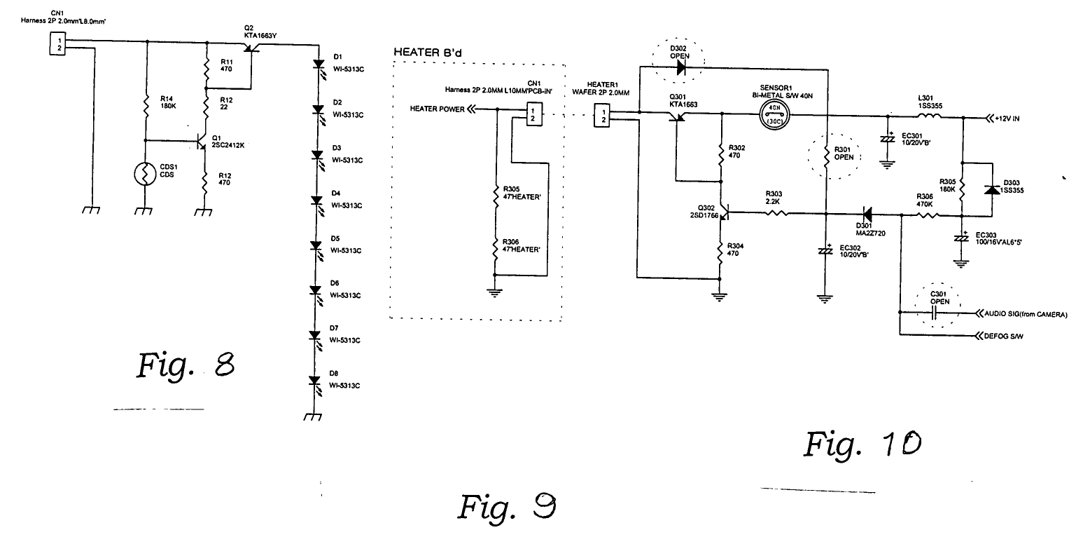

In one embodiment of the present invention apparatus, a scanning video camera system is mounted on a rear panel 10 of a motor home 20, as shown in FIG. 4 of the accompanying illustrations. Now referring to FIG. 1, we see that the apparatus comprises a chassis 30 that pivotally engages a scanning assembly 40. The scanning assembly 40 is made up of a video camera 42 held in a frame 46, which is mounted on a positioning gear 48. The positioning gear 48 is rotationally mounted to the chassis 30, thereby enabling the positioning gear 48 to rotate over a selected arc 50 so that the camera 42 may have an extended field of view 60 as shown in FIG. 4. The chassis 30 fixedly mounts a drive motor 32 including a drive gear 34, the drive gear 34 engaging the positioning gear 48 for rotating the scanning assembly 40 over the selected arc 50. The frame 46 provides opposing tabs 46′ positioned for contact with the chassis 30 at ends of the selected arc 50 so as to limit the range of motion of the camera 42. The tabs 46′ are in opposite positions as shown in FIG. 2. The chassis 30, scanning assembly 40 and drive motor 32 are mounted, using standard hardware, within a case 70 preferably of rugged construction. The case includes a case cover 72 which provides a window 74 of such curvature as to maintain a constant space between the lens of camera 42 and the window 74 as the camera 42 scans over the selected arc 50. This constant spacing enables the camera lens to remain approximately parallel with the interior surface of window 74 so that light reflections are minimized and a superior video image is produced. Preferably, the case cover 72 is sealed by a rubber gasket (not shown) to the case 70 so that the interior of the case 70 is able to be maintained in a dry and clean condition. Preferably, a video monitor 80 is positioned within a cab 22 of the motor home 20 and is engaged, by wire or wireless for signal communication with the camera 42 and its circuit board assembly 44 (FIG. 3) so as to enable remote viewing from the cab 22 of the scene at the rear of the motor home as best illustrated in FIG. 4.

Preferably, at least one heater element 45 is mounted and positioned for movement with the camera 42 in adjacency to the window 74 for defogging the window. Such a heater element 45 may be a thermistor or a simple resistor, for instance.

Preferably, at least one infrared lamp 43 is mounted onto the chassis 30 in a position for directing infrared illumination through the window 74. To prevent the camera 42 from seeing such infrared illumination, a partition 90 is positioned between the at least one infrared lamp 43 and the camera 42, as shown in FIG. 3.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as. including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A scanning video camera system apparatus comprising: a chassis pivotally engaging a scanning assembly, the scanning assembly having a video camera, a frame and a positioning gear, thereby enabling the scanning assembly to rotate over a selected arc for directing the video camera; the chassis fixedly mounting a drive motor including a drive gear, the drive gear engaging the positioning gear for rotating the scanning assembly over the selected arc; the frame providing opposing tabs positioned for contact with the chassis at ends of the selected arc so as to limit the range of arcuate motion of the camera; the chassis, scanning assembly and drive motor mounted within a case with a circuit board assembly for processing video signals from the camera; the case providing a window of such curvature as to maintain a constant space between the camera and the window as the camera scans the selected arc.

2. The apparatus of claim 1 further providing a heater element positioned for movement with the positioning gear in adjacency to the window for defogging the window.

3. The apparatus of claim 1 further providing at least one infrared lamp mounted onto the chassis in a position for directing infrared illumination through the window.

4. The apparatus of claim 3 further providing a partition positioned between the at least one infrared lamp and the camera such that infrared illumination cannot enter the camera.

5. A scanning video camera system apparatus for mounting on a motor home, the apparatus comprising: a chassis pivotally engaging a scanning assembly, the scanning assembly having a video camera, a frame and a positioning gear, thereby enabling the scanning assembly to rotate over a selected arc for directing a field of view of the video camera; the chassis fixedly mounting a drive motor including a drive gear, the drive gear engaging the positioning gear for rotating the scanning assembly; the frame providing opposing tabs positioned for contact with the chassis at ends of the selected arc so as to limit the range of arcuate motion of the camera; the chassis, scanning assembly and drive motor mounted within a case with a circuit board assembly for processing video signals from the camera; the case providing a window of such curvature as to maintain a constant space between the camera and the window as the camera scans the selected arc, and a video monitor positioned within a cab of the motor home and engaged for signal communication with the apparatus so as to enable remote viewing from the cab.

6. The apparatus of claim 5 further providing a heater element positioned for movement with the scanning assembly in adjacency to the window for defogging the window.

7. The apparatus of claim 5 further providing at least one infrared lamp mounted onto the chassis in a position for directing infrared illumination through the window.

8. The apparatus of claim 7 further providing a partition positioned between the at least one infrared lamp and the camera such that infrared illumination cannot enter the camera.
